(19) United States
(12) Patent Application Publication
(10) Pub. No.: US 2020/0294015 A1
(43) Pub. Date: Sep. 17, 2020

(54) METHOD OF LENDING ELECTRONIC BOOK

(71) Applicant: FUJIAN FOXIT SOFTWARE DEVELOPMENT JOINT STOCK CO., LTD., Fuzhou City (CN)

(72) Inventor: Jianping MEI, Fuzhou City (CN)

(21) Appl. No.: 15/781,635

(22) PCT Filed: Nov. 8, 2016
(86) PCT No.: PCT/CN2016/000618

§ 371 Date: Jun. 5, 2018

(30) Foreign Application Priority Data
Dec. 9, 2015 (CN) 201510905755.0

(51) Int. Cl. G06Q 20/12; G06F 21/10; H04L 12/58

(52) U.S. Cl. CPC G06Q 20/1235; H04L 51/32; G06F 21/105

(57) ABSTRACT

A method of lending an electronic book. The method comprises the following steps: when a user purchases a document in a book shop, providing the purchasing user with an authorized license of the document through a user center server, generating an identification uniquely corresponding to the purchasing user and the document, and allowing the purchasing user to have control over the transfer of a reading authority of the document (S110); allowing the purchasing user to establish a social networking group based on the document according to the identification through a DRM client, allowing users within the social networking group to share reading reflections, and transferring, according to an authority transfer request of a user within the social networking group, the reading authority and a reading time period of the document to the user (S120); and the user reading the document according to the received reading authority and reading time period of the document (S130).

### TECHNICAL FIELD

The present invention relates to a technical field of using an authority control for DRM (digital rights management) documents, in particular, to a method of lending an electronic book.

### BACKGROUND

A frequently-used method of lending a book generally comprises the steps: a user logging in, selecting a book required by the user, viewing the book introduction or viewing several pages for free, and then obtaining a lending authorization (including a lending time period) by purchasing or applying for a membership if he/she is interested in the book; a server recording an authorization control of the user or offline storing the authorized authority information; and finally, the user decrypting an encrypted book after passing an authorization authentication to obtain a reading authority for the original text, when the user is online or offline.

However, when an electronic book is lent, the book is authorized to a designated person, and the lending time period of the book is specified. However, within this lending time period, the user may not view this document for a long time, therefore, the interests of the user cannot be maximized.

### SUMMARY OF THE INVENTION

The present invention provides a method of lending an electronic book, which is used for sharing reading experiences among different individuals with one-time lending behaviors, increasing authorized transfer mechanisms, and ensuring that the number of transferring of users in one lending time period is maximized, to enable a document to be really provided for users who need and have time to read at each moment.

To achieve the above objective, the present disclosure provides a method of lending an electronic book, comprising the following steps:

when a document is purchased by a user in a book mall, providing the purchasing user with an authorized license of the document via a user center server, generating an identification uniquely corresponding to the purchasing user and the document, and allowing the purchasing user to control transferring a reading authority for the document;

a DRM (digital rights management) client allowing the purchasing user to establish, according to the identification, a social network based on the document, allowing users within the social network to share reading experiences, and transferring, according to an authority transfer request of a user within the social network, the reading authority and a reading time period of the document to the user; and the user reading the document according to the reading authority and the reading time period of the document previously transferred to the user.

Further, the method of lending an electronic book further comprises the following step:

according to an authority transfer request made by another user within the social networking group, the user transferring the reading authority and the reading time period of the document to the other user making the authority transfer request.

Further, the method of lending an electronic book further comprises the following step:

according to the identification, allowing the purchasing user to withdraw transferring the authority of the document within the social networking group.

Further, the method of lending an electronic book further comprises the following step:

when the authority of reading the document purchased by the purchasing user is expired, according to the identification, the book mall automatically withdrawing the authority of reading the document within the social network.

Further, the book mall and/or the purchasing user set/sets a limitation on how many times the transfer could be made with respect to the identification.

Further, when the authority of the document is transferred, the method further comprises: detecting a device of the user making the authority transfer request, and only allowing to transfer the reading authority to a user corresponding to a specific device.

Further, the method of lending an electronic book further comprises the following steps: based on the identification of the document, the purchasing user tracking and collecting user data of the document, and effectively utilizing free time of the document by using the collected user data.

The present invention is used for sharing reading experiences among different individuals with one-time lending behaviors, increasing authorized transfer mechanisms (such as the number of transferring, specific devices corresponding to transferring individuals), and ensuring that the number of transferring of users in one lending time period is maximized, to enable a document to be really provided for users who need and have time to read at each moment.

### BRIEF DESCRIPTION OF THE DRAWINGS

To illustrate the technical solution in embodiments of the present disclosure or in the prior art more clearly, the accompanying drawings for describing the embodiments or the prior art are introduced briefly in the following. Obviously, the accompanying drawings in the following description are only some embodiments of the present disclosure. Persons of ordinary skill in the art can obtain other drawings according to the accompanying drawings without paying any creative efforts.

FIG. 1 is a flow chart of a method of lending an electronic book of one embodiment of the present disclosure.

### DETAILED DESCRIPTION OF THE EMBODIMENTS

The technical solutions in the embodiments of the present disclosure will be described clearly and completely below in combination with the drawings in the embodiments of the present disclosure. Obviously, the described embodiments are only a part of the embodiments of the present disclosure, but not all of the embodiments. Based on the embodiments of the present disclosure, all other embodiments obtained by those ordinary skilled in the art without contributing creative labor belong to the protection scope of the present disclosure.

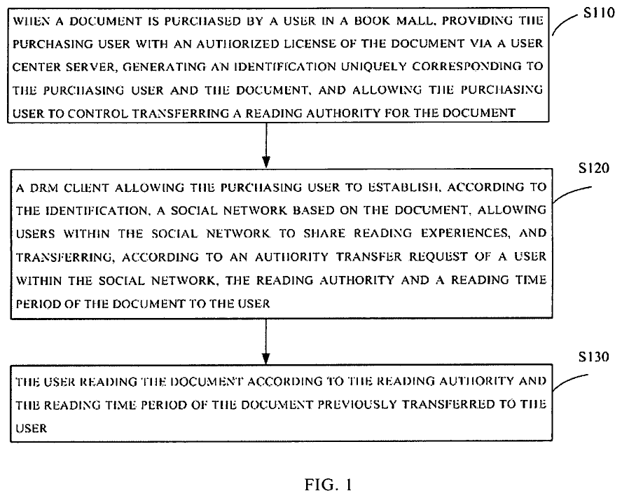

FIG. 1 is a flow chart of a method of lending an electronic book of one embodiment of the present disclosure. As shown in the FIG. 1, the method of lending an electronic book comprises the following steps:

S110: When a document is purchased by a user in a book mall, providing the purchasing user with an authorized license of the document via a user center server, generating an identification uniquely corresponding to the purchasing user and the document, and allowing the purchasing user to control transferring a reading authority for the document;

S120: A DRM (digital rights management) client allowing the purchasing user to establish, according to the identification, a social network based on the document, allowing users within the social network to share reading experiences, and transferring, according to an authority transfer request of a user within the social network, the reading authority and the reading time period of the document to the user; and

S130: The user reading the document according to the reading authority and the reading time period of the document previously transferred to the user.

Further, the method of lending an electronic book further comprises the following step:

according to an authority transfer request made by another user within the social networking group, the user transferring the reading authority and the reading time period of the document to the other user making the authority transfer request.

Further, the method of lending an electronic book further comprises the following step:

according to the identification, allowing the purchasing user to withdraw transferring the authority of the document within the social networking group.

Further, the method of lending an electronic book further comprises the following step:

when the authority of reading the document purchased by the purchasing user is expired, according to the identification, the book mall automatically withdrawing the authority of reading the document within the social network.

Further, the book mall and/or the purchasing user set/sets a limitation on how many times the transfer could be made with respect to the identification.

Further, when the authority of the document is transferred, the method further comprises: detecting a device of the user making the authority transfer request, and only allowing to transfer the reading authority to a user corresponding to a specific device.

Further, the method of lending an electronic book further comprises the following step:

based on the identification of the document, the purchasing user tracking and collecting user data of the document, and effectively utilizing free time of the document by using the collected user data.

The following is a preferred embodiment of the present disclosure:

First, the book mall on a website encrypts all books, designates specific users via a user center, and arranges and layouts authority information about corresponding users via an authority licensing center. In the authority, we can arrange and layout transferring authorized by a user, the number of transferring, designated specific devices and so on. Based on this, a more flexible fee charging mode may be provided. A user A purchases a lending authority for a book, selects the number of transferring according to a required time period, transfers the lending authority to another user for viewing the book in the time period, assists the other user in logging in a book reading client, acquires collected user data, and establishes a social network based on the document, so as to transfer the lending authority in response to actual needs. The specific process is as follows:

[1] The book mall provides the purchasing user with a license and arranges and layouts a authority transfer and a authority control via a user center;

[2] The purchasing user establishes a social network based on the purchased document. Users joining the social network may share document experiences via the social network. Most importantly, the authority transfer provides a valid basis to provide the document to persons who urgently desires reading. For example, a terminal establishing the social network may also collect the behavior of users (mainly the behavior of users who have already obtained the reading authority) within the social network in addition to sharing reading experiences. These collected metadata of the users who have already obtained the reading authority are analyzed, to obtain whether these users effectively use the document (for example, whether the document is being read or the time duration of reading the document within a period of time is less than a set threshold value). If the analysis result indicates that a user (s) is not using the document effectively, the authority of reading the document may be transferred to another user within the social network who really need to read the book, according to a request of the other user within the social networking group;

[3] The authority may be transferred among different users, however, the final withdrawing authority belongs to the purchasing user;

[4] When a final lending time period of the book is expired, the book mall may withdraw the authority of the purchasing user. The DRM (digital rights management) controls terminating the purchasing user's transfer authority and the purchasing user's usage authority transferred to other individuals.

The above-mentioned embodiment is used for sharing reading experiences among different individuals with one-time lending behaviors, increasing authorized transfer mechanisms (including number of times of transfer, specific devices corresponding to transfer individuals), and ensuring that the number of transferring of users in one lending time period is maximized, to enable a document to be really provided for users who need and have time to read at each moment.

The purchasing user transfers the authority to the other user within a designated time period. For example, the purchasing user transfers the authority to a user B, and the user B transfers the authority to a user C. The number of transferring is designated. The final purchasing user may withdraw the authority, and may establish a user social network for a document based on the unique identification of the document, so as to transfer the authority. According to the unique identification of the document, the purchasing user may also track user data of the document, effectively use free time of the document according to the collected information, track behavior data of the user who obtains the authority, and parse these metadata to know whether the user is effectively using the document. After a short time analysis, by a confirmation mode of contacting the user, the document is really authorized to the other user queuing for applying for the document within the social network.

It will be understood by those ordinary skilled in the art that: the drawings are only schematic diagrams of one embodiment, and the modules or processes in the drawings are not necessarily required for implementation of the present disclosure.

It will be understood by those ordinary skilled in the art that: the modules in the device of the embodiment may be distributed in the device of the embodiment according to the description of the embodiment, and may be located in one or more devices different from that of the present embodiment by making corresponding changes as well. The modules of the above embodiment may be combined into one module or may be further split into multiple sub-modules.

Finally, it should be noted that: the above embodiment is only used for explaining the technical solution of the present disclosure, but is not used for limiting same; although the present disclosure is described in detail with reference to the foregoing embodiment, it will be understood by those ordinary skilled in the art that: modifications may be made to the technical solution recorded in the foregoing embodiment, or equivalent replacements may be made to some of the technical features thereof; and these modifications or replacements do not make the essence of corresponding technical solutions depart from the spirit and scope of the technical solution of the embodiment of the present disclosure.

1. A method of lending an electronic book, comprising the following steps:
when a document is purchased by a user in a book mall, providing the purchasing user with an authorized license of the document via a user center server, generating an identification uniquely corresponding to the purchasing user and the document, and allowing the purchasing user to control transferring a reading authority for the document;
a DRM client allowing the purchasing user to establish, according to the identification, a social network based on the document, allowing users within the social network to share reading experiences, and transferring, according to an authority transfer request of a user within the social network, the reading authority and a reading time period of the document to the user; and
the user reading the document according to the reading authority and the reading time period of the document previously transferred to the user.

2. The method of lending an electronic book according to claim 1, further comprising the following step:
according to an authority transfer request made by another user within the social networking group, the user transferring the reading authority and the reading time period of the document to the other user making the authority transfer request.

3. The method of lending an electronic book according to claim 1, further comprising the following step:
according to the identification, allowing the purchasing user to withdraw transferring the authority of the document within the social networking group.

4. The method of lending an electronic book according to claim 1, further comprising the following step:
when the authority of reading the document purchased by the purchasing user is expired, according to the identification, the book mall automatically withdrawing the authority of reading the document within the social network.

5. The method of lending an electronic book according to claim 1, wherein the book mall and/or the purchasing user set/sets a limitation on how many times the transfer could be made with respect to the identification.

6. The method of lending an electronic book according to claim 1, further comprising: when the authority of the document is transferred, detecting a device of the user making the authority transfer request, and only allowing to transfer the reading authority to a user corresponding to a specific device.

7. The method of lending an electronic book according to claim 1, further comprising the following steps:
based on the identification of the document, the purchasing user tracking and collecting user data of the document, and effectively utilizing free time of the document by using the collected user data.
